(19) United States
(12) Patent Application Publication
(10) Pub. No.: US 2010/0140048 A1
(43) Pub. Date: Jun. 10, 2010

(54) Dynamic Buffer

(75) Inventor: Giuseppe MONTI, Pianoro (Bologna) (IT)

Correspondence Address: WILLIAM J. SAPONE;COLEMAN SUDOL SAPONE P.C., 714 COLORADO AVENUE, BRIDGE PORT, CT, 06605, US

(73) Assignee: Marchesini Group S.p.A., Pianoro (Bologna) (IT)

(21) Appl. No.: 12/617,906

(22) Filed: Nov. 13, 2009

(30) Foreign Application Priority Data
Dec. 4, 2008 (IT) BO2008A 000732

(51) Int. Cl. B65G 37/00

(52) U.S. Cl. 198/347.1

(57) ABSTRACT

A dynamic buffer is associated to two consecutive conveyor lines, respectively belonging to a first machine and a second machine and comprises: a storage conveyor, in which an operating station for inlet and outlet of articles is defined, situated in proximity of an unloading position of the first line; handling organs for transferring the articles from the unloading position to the second line, in a condition of normal functioning of the second machine, or to the operating station of the storage conveyor, in a halted condition of the second machine. On restarting, the second machine is accelerated and the handling organs pick up the articles stored in the storage conveyor from the operating station, in the same order of insertion and in alternation with the articles supplied towards the unloading position; this stage proceeds up to the emptying of the storage conveyor.

### BACKGROUND OF THE INVENTION

The invention relates to the technical sector concerning connecting systems between two automatic machines arranged in line.

The simplest connecting system is constituted by a conveyor line which collects articles exiting from a first machine in order to transfer them to a second machine.

Located upstream and downstream of the conveyor line are handling organs (for example of the pick and place type, or robots or other besides) which are able to perform a transfer of the articles, respectively from the first machine to the conveyor line and from the conveyor line to the second machine.

The conveyor line can be constituted by a simple conveyor belt, or a box conveyor; alternatively trays can be provided, known to technical experts in the sector as godets, provided with seatings and formed in order to receive articles.

The use of trays, or godets, is preferred when the articles are fragile and/or of a particular shape and/or a predetermined orientation of the articles by the second machine which receives them downstream.

Independently of the conformation of the conveyor line, a constructional layout such as the one described herein above is rather rigid, in the sense that it is able to perform its tasks only under conditions of regular functioning of both the upstream and the downstream machines.

In many applications there is a need to make these systems more flexible, such that they can cope with temporary unforeseen functioning faults or brief halts of a machine without the other machine being affected.

In order to obtain the desired characteristics of flexibility, the connecting systems are from time to time provided with temporary storage devices known as buffers which are built according to the specific requirements of at least one or both the machines involved.

In a case in which the more “delicate” machine is upstream, the buffers are designed to house the articles coming from the machine when the downstream machine has problems.

Thereafter, once the regular functioning of the downstream machine has been resumed, the storage of articles in the buffer is progressively reduced, thanks to the fact that the machine is able to function at an operational speed which is greater than that of the upstream machine.

Certain types of products, for example pharmaceutical products, are damaged or altered if kept for too long in unsuitable conditions of temperature and/or of contact with air, with respect to what is expected for normal completion of the productive cycle.

A circumstance that can determine the faulty conditions obviously relates to the accumulation of the articles in a buffer and, in particular, the subsequent stage of emptying it. In order that all the stored articles stored in the buffer stay there for about the same length of time, the emptying has to start from the first article that entered it, i.e. in the same order in which the articles were introduced.

### SUMMARY OF THE INVENTION

The aim of the present invention is therefore to provide a dynamic buffer, to be interposed between an upstream machine and a downstream machine, conformed such as to store articles coming from the upstream machine in a case of a brief pause in the downstream machine and which if needed can return the stored articles in the same order of introduction, in order to insert them in the downstream machine after it restarts.

A further aim of the invention consists in providing a dynamic buffer in which the storage zone is capacious and at the same time compact.

A still further aim of the invention consists in providing a dynamic buffer which is extremely versatile, such as to be easily configurable for loose articles, packed particles or articles to be treated together with relative conveyor trays (godets).

The aforementioned aims are obtained by means of a dynamic buffer, associated to two conveyor lines, a first line of the conveyor lines being supplied with articles coming from a first machine, and a second line of the conveyor lines supplying a second machine with the articles, motorizing organs of the conveyor lines being managed by a command and control unit in accordance with operating conditions of the machines, the dynamic buffer comprising: a buffer conveyor constituted by a plurality of platforms arranged in sequence along a ring-wound trajectory, with each of the platforms being destined to receive at least an article; first handling organs commanded and controlled by the command and control unit in order to cyclically transfer the articles from the first line to the second line; second handling organs, commanded and controlled by the command and control unit, acting between an operating station in which the platforms of the buffer conveyor transit and one or the other of the lines, which second handling organs during a reduction or a halting of a productivity of the second machine are apt to displace the articles from the first line to corresponding platforms of the buffer conveyor, and which second handling organs are further destined, once productivity of the second machine has increased or returned to normal and in phase relation both with an activation of the first handling organs and with an increase in velocity of the second line, to pick-up the articles from the platforms in a predetermined order such as to place the articles in the second line in a predetermined alternation with the articles transferred onto the second line by the first handling organs, up to when the buffer conveyor is completely evacuated.

### BRIEF DESCRIPTION OF THE DRAWINGS

The characteristics of the invention will better emerge from the following description of a preferred embodiment of the dynamic buffer in object, according to what is reported in the claims and with the aid of the accompanying tables of the drawings, in which:

FIG. 1 is a perspective view of the dynamic buffer of the invention;

FIG. 2 is a perspective larger-scale view of a platform of a buffer conveyor as provided for the buffer of FIG. 1;

FIG. 3 is schematic plan view of the dynamic buffer of FIG. 1, in a normal functioning condition of the machines;

FIG. 4 is a lateral view of the storage conveyor relating to the condition of FIG. 3;

FIG. 5 is a similar view to that of FIG. 3 illustrated a halt conditions of the downstream machine;

FIG. 6 is a lateral view of the storage conveyor relating to the situation of FIG. 5;

FIGS. 7A, 7B are plan views of successive first stages following the re-starting of the downstream machine;

FIGS. 8A, 8B are two lateral views of the storage conveyor in relation to the situations of FIGS. 7A, 7B;

FIGS. 9A, 9B, 9C are plan views of further stages, following the first stages, after the restarting of the downstream machine;

FIGS. 10A, 10B, 10C are lateral views of the storage conveyor relating to the situations of FIGS. 9A, 9B, 9C.

### DESCRIPTION OF THE PREFERRED EMBODIMENTS

With reference to the figures of the drawings, 1 denotes the dynamic buffer in object in its entirety.

The dynamic buffer 1 is associated to two conveyor lines L1, L2, the first of which L1 is supplied with articles 2 arriving from a first machines MI and supplying, via the second line L2, a second machine M2 with the articles 2. In the embodiment of the figures, the two lines L1, L2 are parallel and arranged in a line, but in reality they could be angled or off-axis.

The motorization organs of the lines L1, L2 (not illustrated) are managed in a known way by a command and control unit K, in accordance with the operating situations of the machines M1, M2 as will be more fully described herein below.

The first conveyor line L1 is, for example, ring-closed and comprises a series of support elements 11, arranged in steps, which are destined to support the articles 2 along the operating branch RS, defined by the upper horizontal branch of the ring; at the end of the operating branch RS there is an unloading position A.

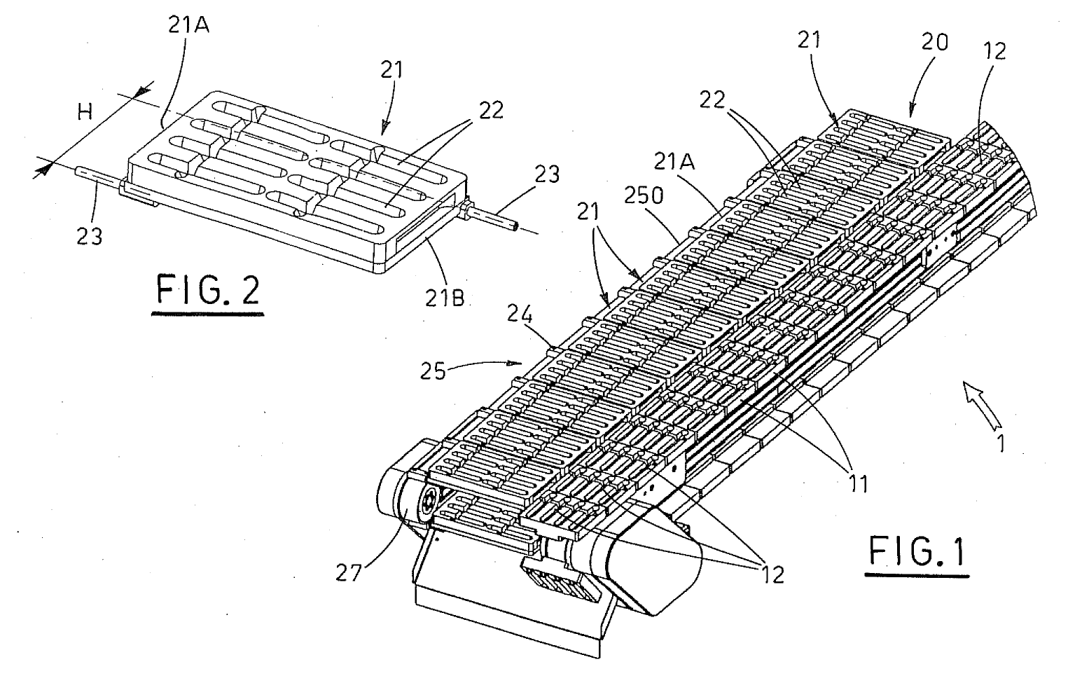

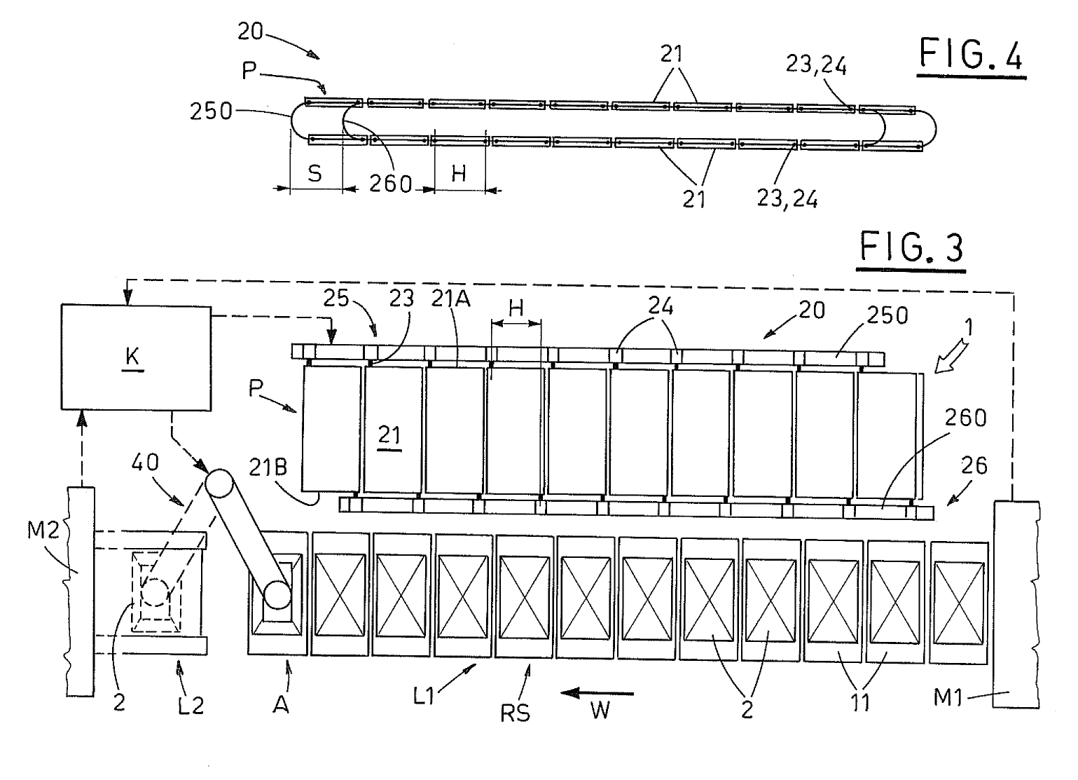

The support elements 11 can be constituted by conveyor trays (known as godets, FIG. 1) having shaped seatings 12 for the articles 2, or by little rest boards (FIG. 3 and following), or by further known organs, such as for example boxes and others.

A storage conveyor 20 is arranged by the side of the first line L1, also developing in a closed ring shape and comprising a series of platforms 21, arranged in steps, destined to support the articles 2.

In the example of the figures, which is not limiting, the storage conveyor 20 develops parallel to the first line L1.

The platforms 21 can exhibit shaped seatings 22 for the articles 2 (FIGS. 1 and 2), for example in the presence of godets in the first line L1 (see FIG. 1), or they can be smooth as illustrated in FIG. 3 onwards.

The platforms 21 are each provided with a pair of pins 23, arranged with offset axes, with predetermined interaxis H and projecting from the relative opposite sides 21A, 21B of the platforms 21 which pins 23 are parallel to the movement direction of the storage conveyor 20 (FIG. 2).

The pins 23 enable each platform 21 to be bilaterally engaged with corresponding bushes 24 arranged in steps along two flexible transmission organs 250, 260 (for example chains or cogged belts) provided respectively in two parallel movement groups 25, 26, destined to be activated in synchrony in a same direction by known-type motor organs which are not illustrated in detail, the activating of which is managed by the command and control unit K.

Each of the flexible transmission organs 250, 260 is ring-wound and closed between respective pairs of pulleys 27, of which only one is visible in FIG. 1; the organs 250, 260 exhibit a same trajectory and development, but the respective pairs of pulleys 27 are horizontally staggered by an amount S which is equal to the offset interaxis H of the pins 23 (see in particular FIGS. 3 and 4).

This constructional solution enables the horizontal trim of the platforms 21 to be maintained unaltered along the whole development of the storage conveyor 20, comprising the curved connecting tracts between the two upper and lower horizontal branches; with an appropriate vertical distance between the branches it is possible to load all the platforms 21 present with relative articles 2, as well as to move the conveyor 20 in either direction.

An operating station P for inlet and outlet of articles is defined at an end of the upper horizontal branch of the storage conveyor 20, which operating station P is situated in proximity of the loading position A of the first line L1.

The buffer 1 further comprises handling organs 40, of substantially known type, for example pick and place, or anthropomorphic robots or others, the activating of which is managed by the command and control panel K.

The handling organs 40 are arranged in a suitable intermediate position between the conveyor lines L1, L2 and the operating station P of the storage conveyor 20 (FIG. 3 and the like) and are destined to pick up the articles 2 arriving in the unloading position A in order to place them in the second line L2, or in order to move them onto corresponding platforms 21, progressively predisposed at the operating station P; the handling organs 40 are also destined to return the articles 2 stored in the storage conveyor 20 from the station P and return them into the second line L2.

In a constructional variant, not illustrated, first and second handling organs are provided in the place of the single handling organs 40 described herein above; in this case, the first handling organs, commanded and controlled by the unit K, perform only the transfer of the articles 2 from the first line L1 to the second line L2, while the second handling organs, also managed by the unit K, intervene, in suitable phase-relation with the first handling organs, in order to perform the transfer of the articles 2 from the first line L1 to the platform 21 of the storage conveyor 20, as well as thereafter to collect the articles 2 stored in the storage conveyor 20 and replace them in turn into the second line L2.

The details of the working modes of the above-described handling organs 40 are evident in the following description of the functioning of the dynamic buffer 1, in the case in which a logic control is preselected that realizes the emptying of the storage conveyor 20 in the same order as an introduction of the articles 2 thereon.

FIG. 3 illustrates a normal functioning condition of the second machine M2, in which the handling organs 40 cyclically perform the transfer of the articles 2 from the unloading position A of the first line L1 to the inlet of the second line L2.

In this condition, the storage conveyor 20 is inoperative, empty and can be kept stationary (FIG. 4).

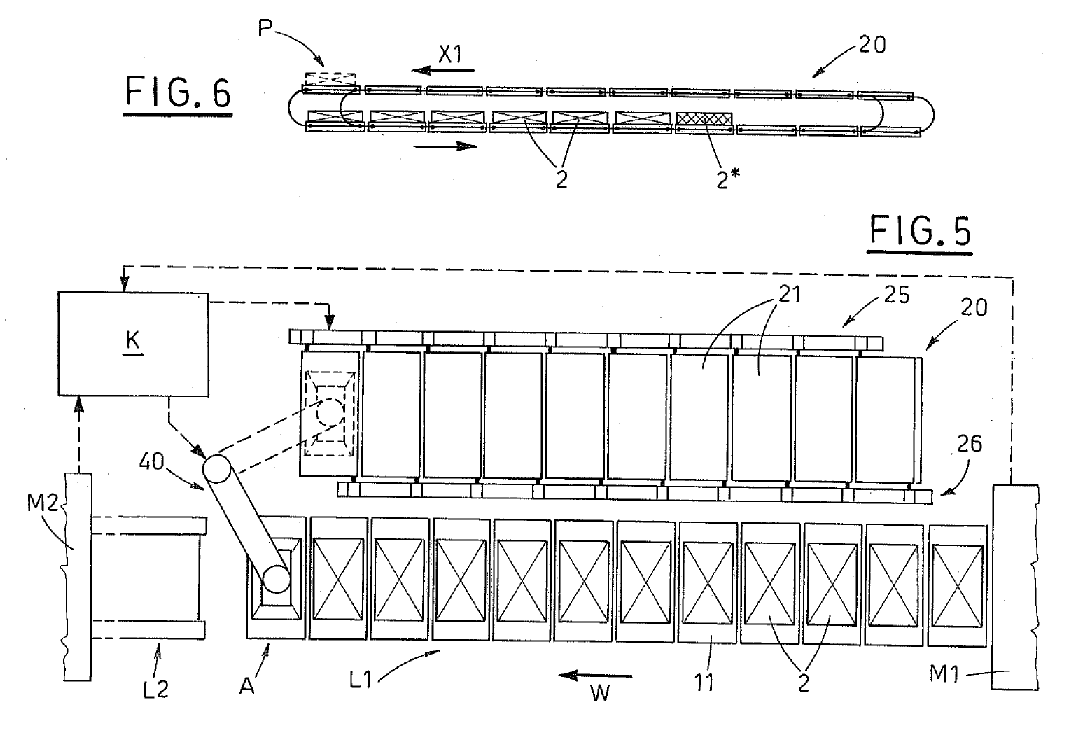

FIG. 5 shows a consequent stage of the halting of the downstream machine; the handling organs 40 in this case cyclically pick up the articles 2 from the loading position A and transfer them onto the platforms 21, neared to the operating station P in a direction X1, for example a same direction as advancement direction W of the first line L1.

FIG. 6 illustrates the articles 2 already stored in the lower branch of the storage conveyor 20, and a different broken line shows the first article 2* introduced following the halting of the downstream machine.

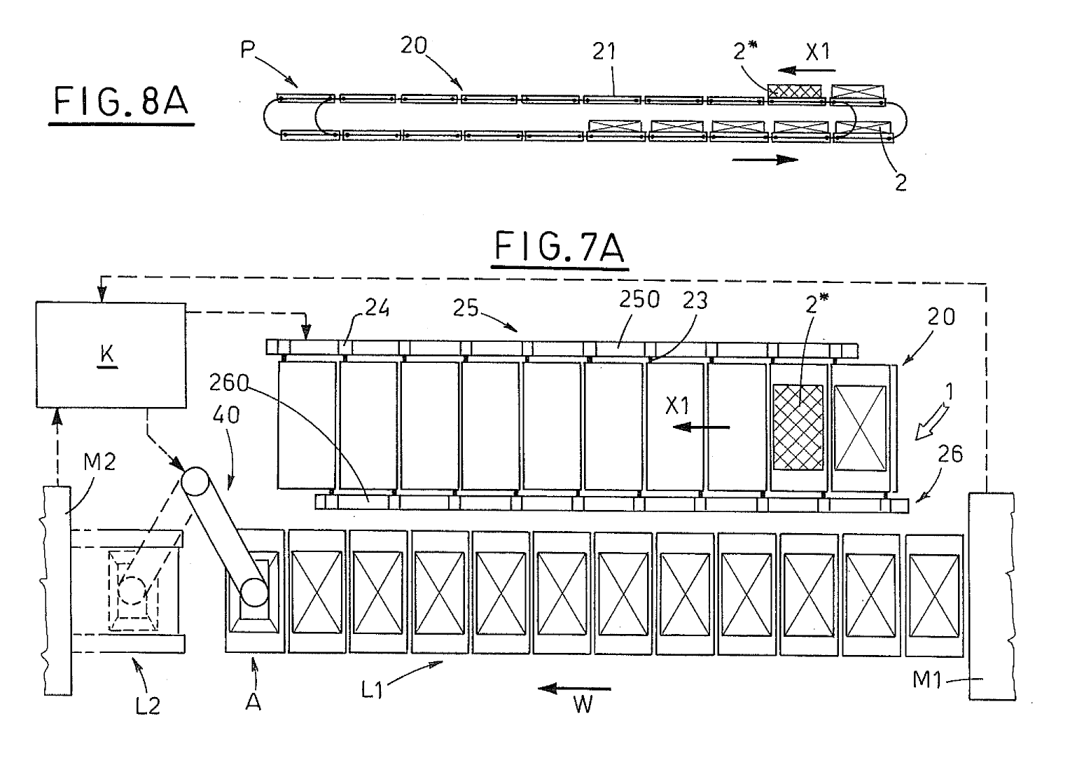

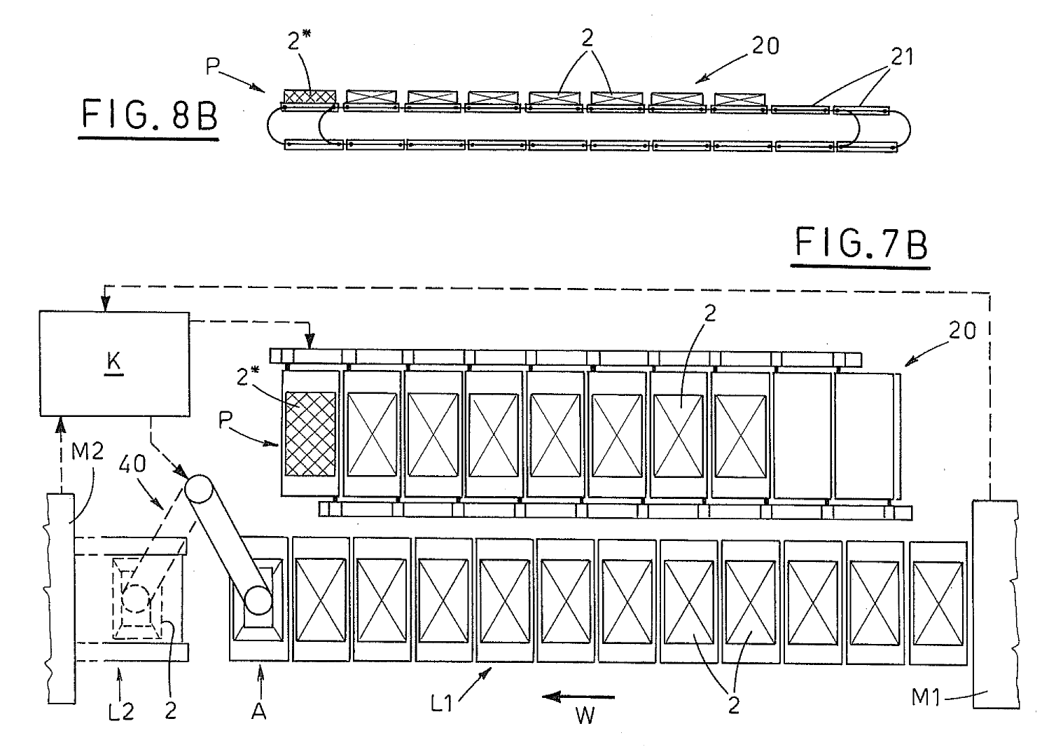

FIGS. 7A, 7B illustrate two successive stages immediately following the return to normal functioning of the downstream machine, in which the handling organs 40 have started transferring the articles 2 from the unloading position A to the second line L2.

In the meantime, the storage conveyor 20 is activated at top speed in the most advantageous direction, for example in direction X1, in order to bring the first article 2* as quickly as possible into the operating station P (see also FIGS. 8A and 8B).

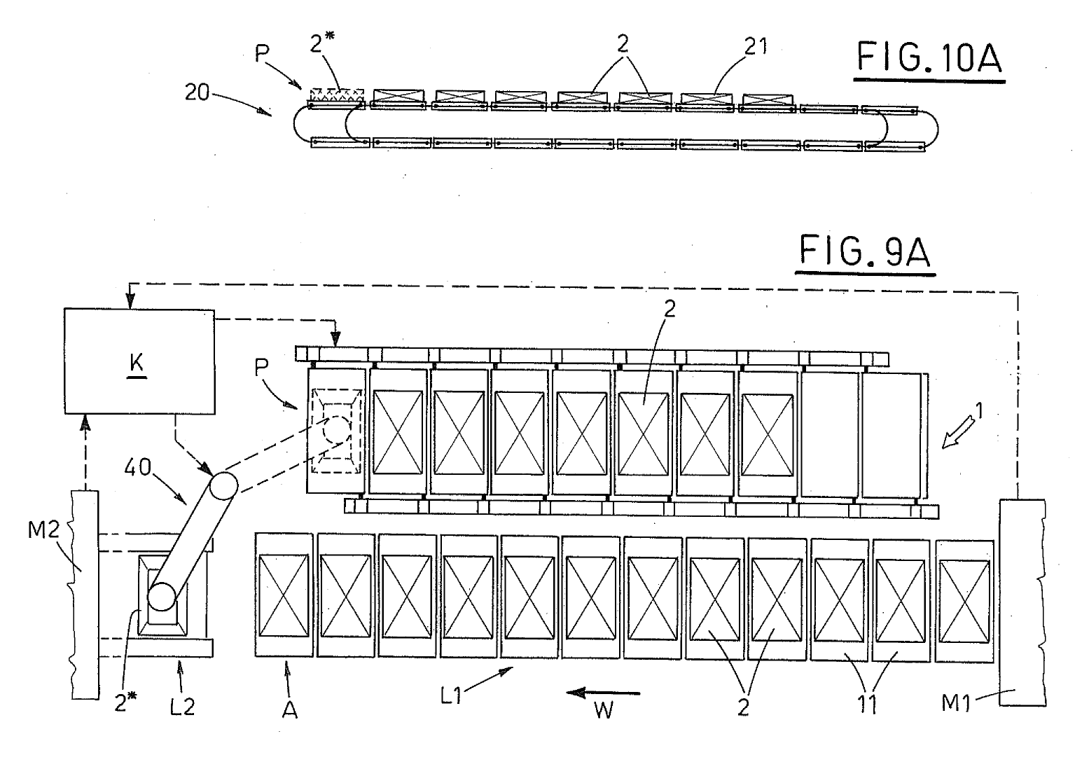

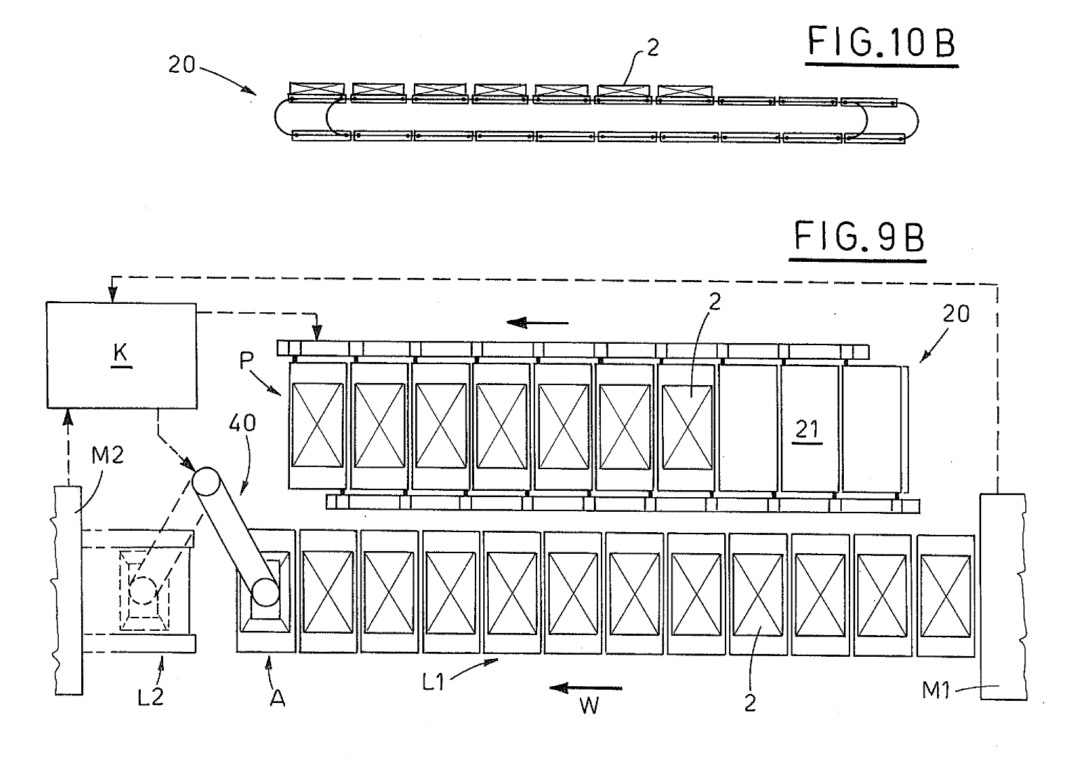

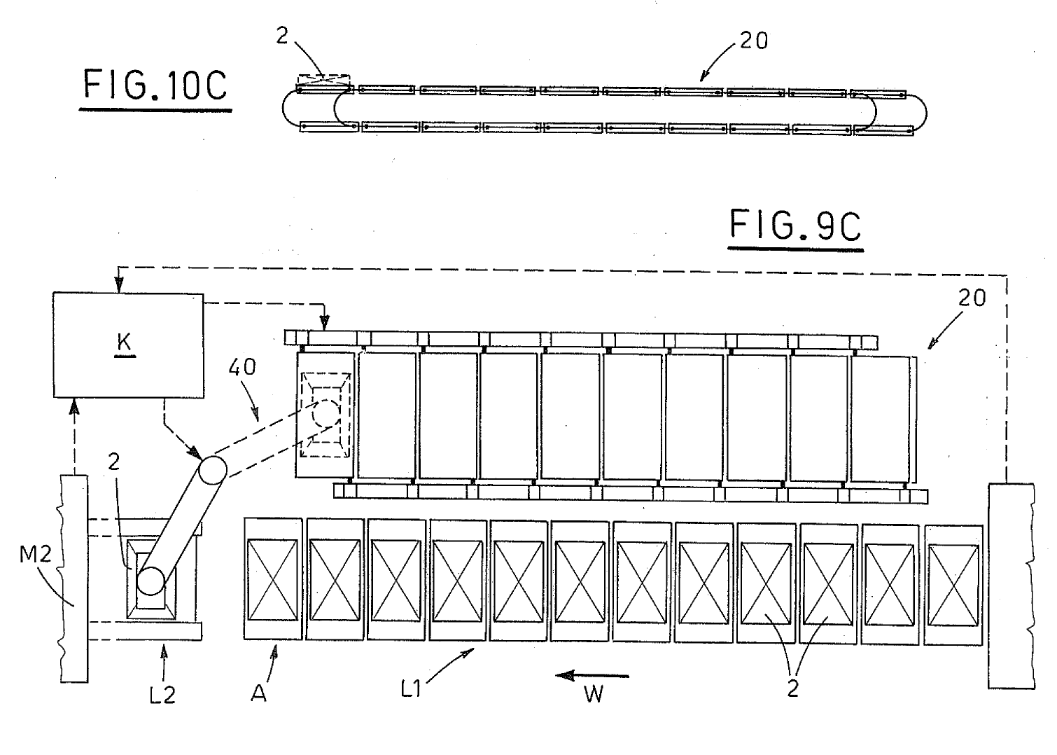

FIG. 9A illustrates the stage in which the handling organs 40 pick up the first article 2* from the operating station P of the storage conveyor 20 (see also FIG. 10A) and deposit the first article 2* on the second conveyor line L2.

In special phase relation with the start of the above-described operation, the operating speed of the second machine M2 is appropriately accelerated, as is the relative conveyor line L2, and the speed of the handling organs 40; the handling organs 40 can pick up, for example alternatingly one by one, both the articles 2 stored in the storage conveyor 20 in the same order as the introduction thereof, and the articles 2 coming from the first machine MI on the first line L1 (see FIGS. 9B, 10B), in order to put them into the second line L2.

In order to absorb the increase in rhythm of the supply of articles 2, the acceleration of the second machine M2 carries on for the time needed to empty the storage conveyor 20 (FIGS. 9C and 10C).

The dynamic buffer 1 is destined to intervene in a case in which the second machine M2 is merely slowed down, instead of halted, with a consequent reduction in productivity.

In this situation (not illustrated) the unit K commands the handling organs 40 such that a part of the articles 2 picked up from the unloading position A is inserted in the second line L2, compatibly with the ability to absorb of the second machine M2, while the excessive part is stored in the storage conveyor 20, in the way described herein above.

When full working productivity of the second machine M2 is restored, the command and control unit K accelerates the second machine M2 and commands the handling organs 40 in the above-described ways in order to empty the storage conveyor 20.

As mentioned in the preamble hereto, the fact of having two machines in line, with the downstream machine having a faster operating speed than the upstream machine, is to be considered of the prior art, being well known by the experts in the sector.

Obviously the dynamic buffer 1 as described herein above can function in a substantially similar way even without taking account of the introduction of the articles into the storage conveyor 20.

The capacity of the dynamic buffer 1 can obviously be changed by modifying the lengthwise development thereof, compatibly with any need to contain the stored articles 2 within a maximum time lapse.

The described dynamic buffer, then, fully attains the set aims, in particular in defining a storage buffer which if required can return the stored articles in the same order in which they were introduced.

The preferred embodiment, described for the storage conveyor, with the possibility of exploiting both upper and lower horizontal branches, and maintaining the platforms in constant trim, is a characteristic of great interest in obtaining the maximum capacity with the minimum volume.

A further advantage of the dynamic buffer of the invention relates to the versatility offered for obtaining specific configurations for loose articles, packed articles or articles to be treated together with relative godets.

The above, however, is intended to be by way of example and non-limiting, so any modifications in details which might become necessary for technical and/or functional reasons are considered to fall within the ambit of protection as defined in the following claims.

What is claimed:

1. A dynamic buffer, associated to two conveyor lines, a first line of the conveyor lines being supplied with articles coming from a first machine, and a second line of the conveyor lines supplying a second machine with the articles, motorizing organs of the conveyor lines being managed by a command and control unit in accordance with operating conditions of the machines, the dynamic buffer comprising: a buffer conveyor constituted by a plurality of platforms arranged in sequence along a ring-wound trajectory, with each of the platforms being destined to receive at least an article; first handling organs commanded and controlled by the command and control unit in order to cyclically transfer the articles from the first line to the second line; second handling organs, commanded and controlled by the command and control unit, acting between an operating station in which the platforms of the buffer conveyor transit and one or the other of the lines, which second handling organs during a reduction or a halting of a productivity of the second machine are apt to displace the articles from the first line to corresponding platforms of the buffer conveyor, and which second handling organs are further destined, once productivity of the second machine has increased or returned to normal and in phase relation both with an activation of the first handling organs and with an increase in velocity of the second line, to pick-up the articles from the platforms in a predetermined order such as to place the articles in the second line in a predetermined alternation with the articles transferred onto the second line by the first handling organs, up to when the buffer conveyor is completely evacuated.

2. The dynamic buffer of claim 1, wherein the buffer conveyor exhibits two superposed branches, respectively an upper branch and a lower branch, with the operating station located at the upper branch.

3. The dynamic buffer of claim 2, wherein the operating station is situated at an end of the upper branch.

4. The dynamic buffer of claim 1, wherein the lines are arranged aligned, wherein the buffer conveyor exhibits two superposed branches, respectively an upper branch and a lower branch, which are parallel to the lines and with the operating station located at the upper branch.

5. The dynamic buffer of claim 1, wherein the first handling organs are interposed between an end of the first line and a start of the second line.

6. The dynamic buffer of claim 1, wherein the first handling organs coincide with the second handling organs.

7. The dynamic buffer of claim 2, wherein the first handling organs coincide with the second handling organs.

8. The dynamic buffer of claim 3, wherein the first handling organs coincide with the second handling organs.

9. The dynamic buffer of claim 4, wherein the first handling organs coincide with the second handling organs.

10. The dynamic buffer of claim 5, wherein the first handling organs coincide with the second handling organs.

11. The dynamic buffer of claim 1, wherein the buffer conveyor comprises two conveyor groups which are parallel and synchronically activatable in two directions, and which are positioned at opposite sides of the platforms, which platforms are each provided with a pair of pins arranged offset and projectingly from the sides thereof, and which pins are apt to engage in corresponding bushings arranged in steps along two flexible transmission organs provided respectively in the two conveyor groups, the flexible transmission organs being horizontally staggered by an amount which is equal to an interaxis between the pivots, in order to enable the horizontal trim of the platforms to be kept unaltered for a whole development of the buffer conveyor, comprising curved connecting tracts between the relative horizontal upper and lower branches thereof.
